(19) United States
(12) Patent Application Publication
(10) Pub. No.: US 2014/0007629 A1
(43) Pub. Date: Jan. 9, 2014

(54) Equipment Security Enclosures

(71) Applicant: Wayne Arendsee, Fort Worth, TX (US)

(72) Inventor: Wayne Arendsee, Fort Worth, TX (US)

(21) Appl. No.: 13/544,677

(22) Filed: Jul. 9, 2012

(51) Int. Cl. E05B 73/00

(52) U.S. Cl. 70/58

(57) ABSTRACT

A security enclosure for equipment may have four substantially planar panels with multiple engagement openings and received on a base. The panels have engagement protrusions along an edge that engage slots in an adjacent pane or an intermediate anchor frame Four side panels, comprise a generally square cross-section enclosure. A top panel is engaged with the side panels using engagement protrusions and cooperating slots, which together with the base, completely enclose the equipment. A puck lock receives a tang fixedly attached to the top panel and engages an opening in the tang with a hasp that is completely enclosed within the lock. An anchor frame may be interposed in the corners between the sides with the sides being connected to the frame. The lower ends of the anchor frame serve as legs to contact the base. Where larger equipment is to be housed, multiple side panels may be joined.

### BACKGROUND OF THE INVENTION

Equipment theft and theft of equipment components (particularly copper components) has become an increasing problem. Although the equipment to be protected is sometimes referred to herein as air conditioning equipment, it will be understood that all types of mechanical, electrical or electronic equipment can be subject to theft, particularly if they are mounted on the exterior of a building.

In a typical theft thieves will strip air conditioning equipment of all the copper parts including tubing, destroying the equipment in the process. Experienced thieves can strip a ground or roof mounted air conditioning condenser of virtually all of the copper content in 5 minutes or less. The speed with which the equipment can be dismantled makes ordinary security measures such as alarm systems valueless because the thieves will be long gone before law enforcement personnel can reach the scene.

The owner of the equipment is increasingly forced to bear increased costs because insurance carriers are beginning to cancel coverage or charge higher premiums if the insured has experienced losses.

Due to the frequency and magnitude of losses, various devices have been proposed, described and in some cases sold. Many of these devices are based on the same basic approach, which is to enclose the equipment in a cage with openings for ventilation. The enclosure is secured to the skid, in the case of roof mounted equipment and to the concrete pad in the case of ground mounted equipment. The skid and concrete pad are referred to collectively as the base.

Prior art devices suffer from unique and common deficiencies. For example, prior art cages that are of sufficient strength to resist common burglar tools such as bolt cutters and wire cutters, are extremely heavy. When the construction is unitary (all 3 or 4 sides and a top welded or otherwise permanently secured together, they cannot be lifted by manpower alone. In some devices the cages are mounted on pivots so that the can be swung over the equipment and laid to rest on the roof substrate or in the case of ground mounted equipment they merely are laid on the ground. Even with the pivot mounts, the weight may be so great that it takes more than one person to pivot the cage out of the way for servicing or replacement of the equipment increasing the required number of workers which increases costs.

At the opposite extreme, where the cage is relatively light weight, it is common for thieves to merely pry the cage apart at the corners, or to use bolt cutters to cut through the bars forming the cage to expose at least one side of the equipment and provide access to remove the copper components. In some cases the lightweight bars telescope to make the enclosure adjustable to fit various sizes and shapes of equipment. Once one side of the cage is breeched, the remaining sides can be easily slipped apart. The motivation for such adjustable designs includes the fact that it is very expensive to buy the tooling to make multiple cages of different sizes. This is brought about by the fact that these designs do not lend themselves to low cost manufacturing techniques such as modern high speed cutting techniques including laser, water-jet or plasma cutters. The designs incorporating tubing also do not lend themselves to low cost forming techniques such as bending brakes. As a consequence it requires new tooling to make custom designs and cannot be accomplished by a mere programming change in computer aided manufacturing (CAM) software.

Another problem arises due to the necessity of locking the cage to the skid, in the case of roof mounted A/C equipment, or a concrete pad, in the case of ground mounted equipment. Typically the locks used are conventional padlocks which are easily defeated with bolt cutters because the hasp of the lock is exposed.

In other cases the thieves may find it easiest merely to unbolt the cage from its base. In many cases the bolts and nuts can be reached and removed by conventional tools. Where security fasteners are employed they typically require special tools that the owner must employ to remove the security fasteners. These tools are frequently misplaced between servicing intervals which results in inconvenience, delay and expense for the owner. For the thief most of these tools are readily available in the market place. Thieves frequently have these tools more readily at hand than does the owner.

### SUMMARY OF THE INVENTION

The exemplary embodiments of the invention address the deficiencies in prior art devices by using high strength sheet metal panels which can be formed by easily customizable CAM cutting and metal bending techniques. The design is inherently modular so that interchangeable panels can be used to form square four sided enclosures with a single panel type. Where larger and more elongated equipment is encountered multiple panels can be connected together to accommodate the larger equipment. A connector panel is used to connect the multiple panels together. This connector panel can employ the same interconnection technique as is utilized in connecting the panels one to the other. For convenience the smaller enclosure is referred to as the ground mount enclosure, and the elongated enclosure as the roof mount, but it will be understood that, where appropriate, the ground mount and roof mount enclosures may be used in either location.

The panels are made of sheet metal and have multiple enlarged openings for ventilation. The “blades” of a bolt cutter are not designed for shearing, but to put sufficient strain on the material until the stress exceeds the ultimate strength of the material, causing failure. The spreading the force of the bolt cutters over sheet metal merely deforms the metal, but does not strain it enough to cause failure. Even if bolt cutters are used to make a series of small tears in the sheet metal it would take more time than the typical theft is willing to spend on site.

Tools of choice for thieves include bolt cutters, wire cutters, wrenches, hammer and chisel, portable drills and pry bars. The enclosure of the invention is intended to prevent ready use of any of those tools.

Fastner covers and fastner cover receivers are provided to prevent access to the fastners while the enclosure is in place.

The sheet metal open structure makes the panel light enough that it is possible for a single worker to raise a panel to roof level using a rope, and for service personnel to remove and lift a panel for access.

A particular interconnection technique is advantageous with the enclosure of the invention. The technique employs engagement protrusions on one component which are received in openings on the adjacent component. When the component mounting the protrusions is slid so that the protrusions slide along the engagement openings to the point at which the protrusions are captured and cannot be removed.

Two types of protrusions/openings configurations have been found to be particularly advantageous when used in the enclosure of the invention. The first type uses L-shaped hooks that are received in straight slots. The second type uses knob-shaped protrusions paired with keyhole slots.

In addition to the panels, for optimum strength, U-shaped anchor frames can be employed to provide vertical legs and a horizontal top to which the panels can be connected. These frames are especially desirable in larger enclosures and where maximum strength is desired. For the smaller lighter-duty enclosures the panels can merely be connected to the adjacent panel.

In either interconnection configuration and either roof-top or ground mounted enclosures the lock type and lock protection are important and the invention provides an especially effective solution. A puck-type lock is employed with no exposed hasp and therefore no access for bolt cutters or similar tools. The lock receives a protruding tang on either a panel or connector panel t. In the exemplary embodiment, the lock is surrounded on at least three sides by a raised shroud of high strength sheet metal. While the shroud is shown with planar sides, it can alternatively be cylindrical. The shroud makes it very difficult to use any tools to extricate the lock from the connected structure. The lock itself has a massive body which bolt cutters can not grip or penetrate. The tang is receive with the lock and is thus protected as well. The lock captures the tang with a hasp that passes through a hole in the tang. The interior hasp that penetrates the tang is completely surrounded by the massive lock housing.

Using the example where the enclosure comprises a square ground mounted configuration the sides are assembled first by engaging the protrusion on each panel with opening on the adjacent panel or the anchor frame. The top panel is engaged with side panels by protrusions on the top panel being received in engagement openings on the top end of the sides and slid into engagement. With the top engaged none of the sides can be removed. With the top locked against sliding movement by the puck lock to prevent further sliding movement, all five panels are locked and cannot be disengaged.

Where ground mounted equipment is on a pad not of sufficient size, or the pad is not of sufficient strength (as in the case of asphalt) a ground mount assembly is employed with legs that can be encased in concrete and an anchor frame to support the enclosure and optionally to support a pan so that the air conditioning equipment can be supported directly by the enclosure.

The operation where a connecting panel is used to create an elongated enclosure is similar to that of the ground mounted configuration. The connecting panel is comprised of at least one panel part which incorporates L-shaped extensions. The connector panels bridge between adjacent side panels and the L-shaped extension provide for the attachment of one or more top panels. All panels have complementary inter-fitting protrusions and engagement opening provisions so that once installed the two halves of the elongated enclosure cannot be disassembled without removing the top panel(s). In this exemplary embodiment the top panel bracket parts include a lock shroud and puck lock on one part and a protruding tang on the other part. The part with the tang is slid into the opening in the puck lock and captured by the interior hasp.

### BRIEF DESCRIPTION OF THE DRAWINGS

FIG. 1 is a perspective view of the security enclosure of the invention configured with four side panels.

FIG. 2 is a perspective view of the roof mount configuration for the invention showing four side panels, two side connector panels, two end panels, two top panels and one top connector panel.

FIG. 3 is an exploded view of the enclosure of FIG. 1 showing the use of an anchor frame to connect between panels and a ground mount assembly with ground mount legs.

FIG. 4 shows a side panel engaged with an anchor frame.

FIG. 5 shows the relationship between the anchor frame and side panel before assembly on a base.

FIG. 6 is a detailed view of area 6 in FIG. 4.

FIG. 7 is a detailed view of area 7 in FIG. 5.

FIG. 8 shows the use of the alternative knob and keyhole slot connectors.

FIG. 9 shows the security enclosure of FIG. 1 supported on a concrete pad with the top panel in position to be engaged with the top edges of the side panels.

FIG. 10 is a detailed view of area 10 in FIG. 9, showing the top panel hooks as they would be positioned prior to lowering the panel and then sliding the panel to engage the hooks in the slots.

FIG. 11 is a detailed view of area 11 of FIG. 9 showing the reinforced tang on the top panel and the shroud for the puck lock.

FIG. 12 shows the enclosure of FIG. 1 with the puck lock in position to engage the tang.

FIG. 13 is a detailed view of area 13 from FIG. 12 showing the multi layered tang protruding into the shroud.

FIG. 14 is an end view of the enclosure of FIG. 1.

FIG. 15 is a sectional view taken along line 15-15 of FIG. 14.

FIG. 16 is a detailed view of area 16 of FIG. 15 showing a hook engaged in a slot.

FIG. 17 is an exploded view of the enclosure of FIG. 1 with the front panel omitted for clarity and showing an exemplary fastener cover and fastener cover receiver.

FIG. 18 show the fastener cover including a fastener cover and fastener cover receiver positioned for installation with the fastener in the form of a bolt to be received in a concrete anchor embedded in the base (not shown).

FIG. 19 shows the enclosure of FIG. 17 assembled with one fastener cover and fastener cover receiver installed (the front panel is omitted for clarity).

FIG. 20 is a detailed view of area 20 on FIG. 19 showing the fastener cover engaging the underside of two adjacent side panels.

FIG. 21 is an exploded view of an enlarged enclosure for roof top mounting including side connector panels and top connector panel with integrated tang and puck lock shroud.

FIG. 22 shows two side panels of an elongated enclosure with one panel installed and the other ready for installation. The two side panels will later be joined together by a side connector panel.

FIG. 23 shows a detailed view of the area 23 on FIG. 22 showing a panel engaged with a mounting rail for use with a roof top skid.

FIG. 24 shows the assembly sequence for attaching three side panels to a top panel.

FIG. 25 shows the three sides engaging the rail mounts and ready to receive the top panel.

FIG. 26 shows the roof mount configuration with two open ended enclosures being secured together by two side connector panels.

FIG. 27 shows the enclosure of FIG. 26 with a top connector panel containing the lock shroud and the side connector panel containing the tang.

FIG. 28 shows the use of a mounting rail to engage the sides with the base in a roof mounted configuration.

FIG. 29 shows the detail of the mounting rail and fasteners before the side 17 is slid into final position.

FIG. 30 shows how access is provided to tighten the fasteners to the base on which the equipment is mounted.

### DETAILED DESCRIPTION OF THE DRAWINGS

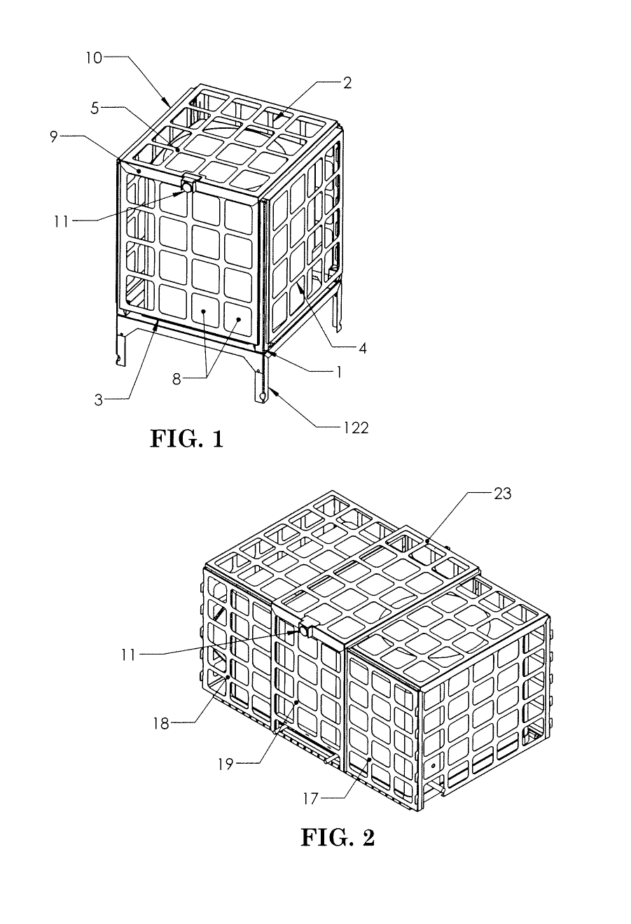

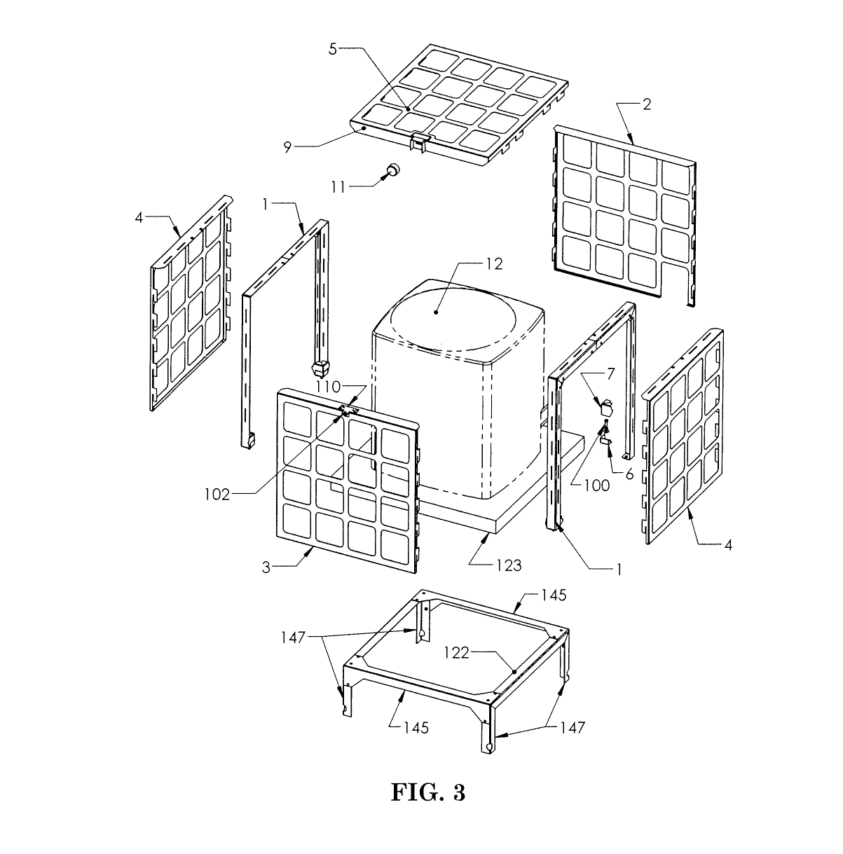

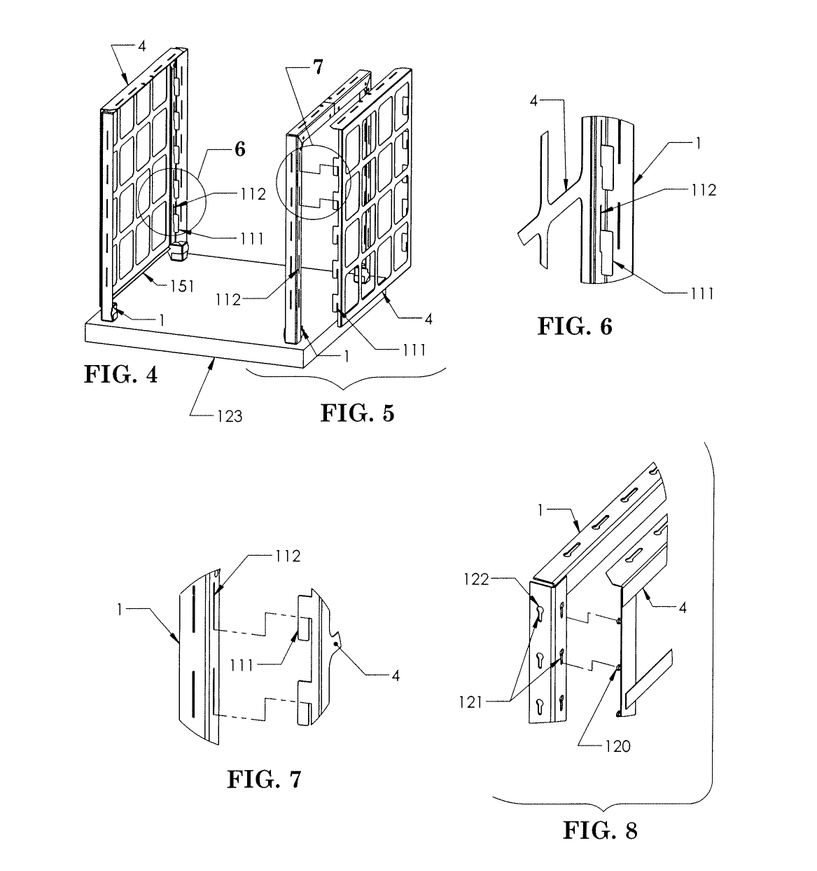

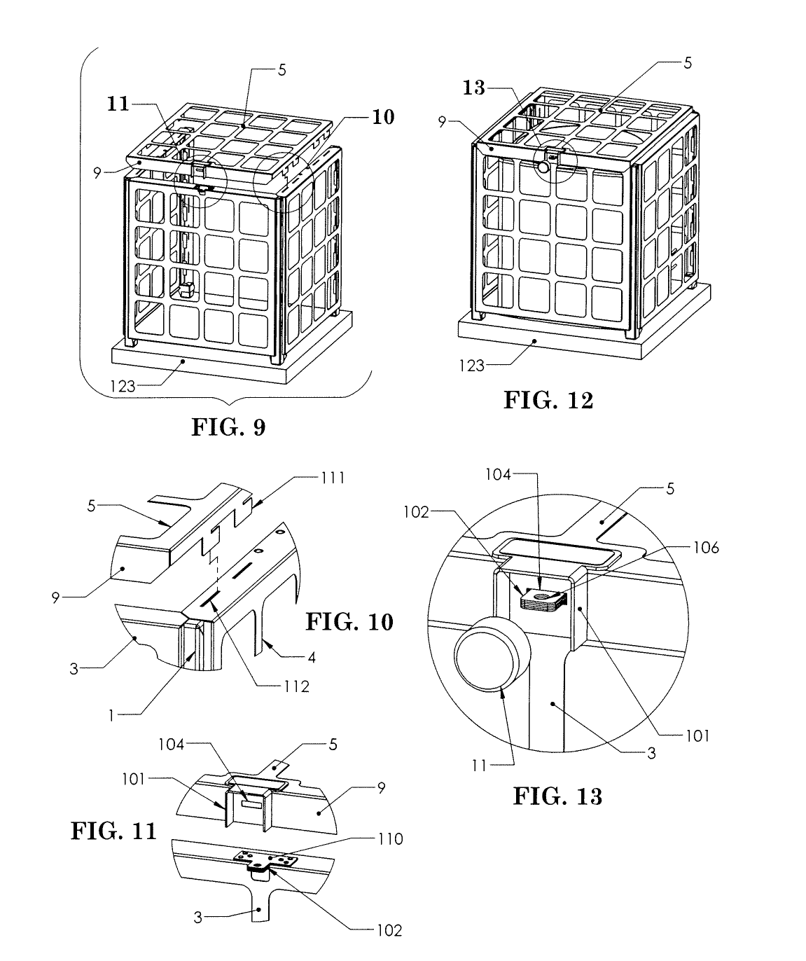

FIG. 1 shows a “ground mount” security enclosure 10 for a single mechanical unit that has 4 side panels of which sides 3 and 4 are fully visible. As will appear the sides panels are generally planar and have a plurality of openings of which openings 8 are representative of the opening throughout the side panels. The sides are joined to anchor frames, such as representative frame 1. The frames are shown connected to the optional ground mount assembly 122. The ground mount assembly is employed when a concrete pad is of insufficient size to mount anchor frames or is of insufficient strength, as in the case of an asphalt pad. The ground mount is received in holes evacuated in the ground then back filled with hi-strength concrete. As noted in the Summary the enclosure is made lighter by the use of sheet metal. In the exemplary embodiment, for example, the side panels are made of sheet steel and weigh approximately 19 pounds each and the entire enclosure weighs approximately 190 pounds.

The enclosure is completed by the top panel 5, which is generally similar to the side panels except for the overlapping flange guard 9 and the provision for the puck lock 11, lock shroud 101 and tang 102 (see FIG. 13).

FIG. 2 is another embodiment of the invention which is generally roof mounted and houses elongated equipment (for example in an air conditioning system, there would be provision for both condenser and evaporator in a single enclosure). FIG. 2 also illustrates an alternative configuration for attaching panels at the corners, where the panels are directly connected together without anchor frames.

Both for economy of manufacturing and for manufacturing inventory reduction, the configuration of FIG. 2, joins two identical side panels, such as the visible side panels 17 and 18. In this configuration the side panels are joined together through a top connector bracket 23 and side connector panels of which connector panel 19 is visible. The top connector bracket 23 and side connector panels 19 have provision for a puck lock 11 with a tang 102 and lock shroud 101 (see FIG. 27).

FIG. 3 is an exploded view of the enclosure of FIG. 1 also showing the fastener cover receiver 6, and the fastener cover 7 together with a bolt 100. These components are shown in greater detail in FIGS. 18 and 20. The side panel 3 is identical to the side panels 4 except for the inclusion of the tang 102 and tang base 110. The top panel 5 is generally identical to the other panels except that it incorporates the lock shroud 101 and tang opening 104 (see FIG. 13) together with the flange guard 9. The equipment 12 shown in phantom lines will normally be the condenser in residential air conditioning installations. A ground mount assembly 122 may be optionally employed where the base 123 is of insufficient size or strength to mount securely the anchor frames to the base. The ground mount assembly has support channels 145 that carry ground mount legs such as exemplary leg 147. These legs are inserted in holes bored in the earth which are then filled in with high-strength (2500 psi concrete.

FIG. 4 shows a side panel 4 connected to an anchor frame 1 through hooks showing the hooks 111 engaged in cooperating slots 112 which are shown in greater detail in FIG. 6. The sides 4 have a horizontal flange of which flange 151 is visible. This flange provides extra stiffness as well as a surface against which fastener cover 7 can engage (See FIG. 20).

FIG. 5 shows a side panel which would be mounted opposite the side panel in FIG. 4. The side panel 4 is shown in position to have the hooks 111 guided into the slots 112 and then slid down so that the hooks overlay the structure of the anchor frame and cannot be removed if sliding is prevented, as by locking the various panels and top panel together.

FIG. 6 shows the engagement of the hooks 111 in the slots 112 in greater detail.

In FIG. 7 the “L-shaped” configuration of the hooks is apparent. The dotted lines indicate the motions that will first insert the hook 111 into the slot 112 and then lower the hook so that it engages the structure of the anchor frame 1.

FIG. 8 shows an alternative configuration for the engagement protrusion and engagement opening structure. Here a knob and keyhole slot are employed. The knobs 120 are inserted into the keyhole opening 122 of the keyhole slot 121 and lowered so that the knob is captured and cannot be removed once the enclosure is locked. The hook and slot and knob and keyhole slot are forms of the inter-fitting engagement protrusions and openings.

FIG. 9 shows the enclosure of FIG. 1 with top panel 5 in position to be inserted and slid to engage the hooks with the slots preparatory to locking the puck lock.

FIG. 10 shows the detail of area 10 in FIG. 9 where the top panel 5 which is slid in the slots 112 until the flange 9 abuts the side panel.

FIG. 11 shows the detail of area 11 in FIG. 9 to reveal the component parts necessary to employ and protect a puck style lock. The top panel 5 has a lock shroud 101 which is sized to closely surround sides of a puck lock. The shroud is attached to the flange 9. A tang opening 104 is sized to receive a reinforced tang 102 with protrudes from a tang base 110. The tang 102 is preferably comprised of multiple layers of sheet steel, to take advantage of the difficultly in using bolt cutters on sheet steel while developing sufficient tensile strength to resist the use of pry bars and similar tools.

FIG. 12 shows the enclosure of FIG. 9 with the top panel installed.

FIG. 13 is a detailed view of area 13 on FIG. 12. As shown, the reinforced tang 102 protrudes through the opening 104 exposing a shackle opening 106. The tang is preferably comprised of multiple layers of sheet steel. This construction both resists bolt cutters and prying which might otherwise break the tang. The puck lock 11 has an internal shackle (not shown) which engages the shackle opening 106 in the tang, when the lock is engaged by using a key or combination (not shown).

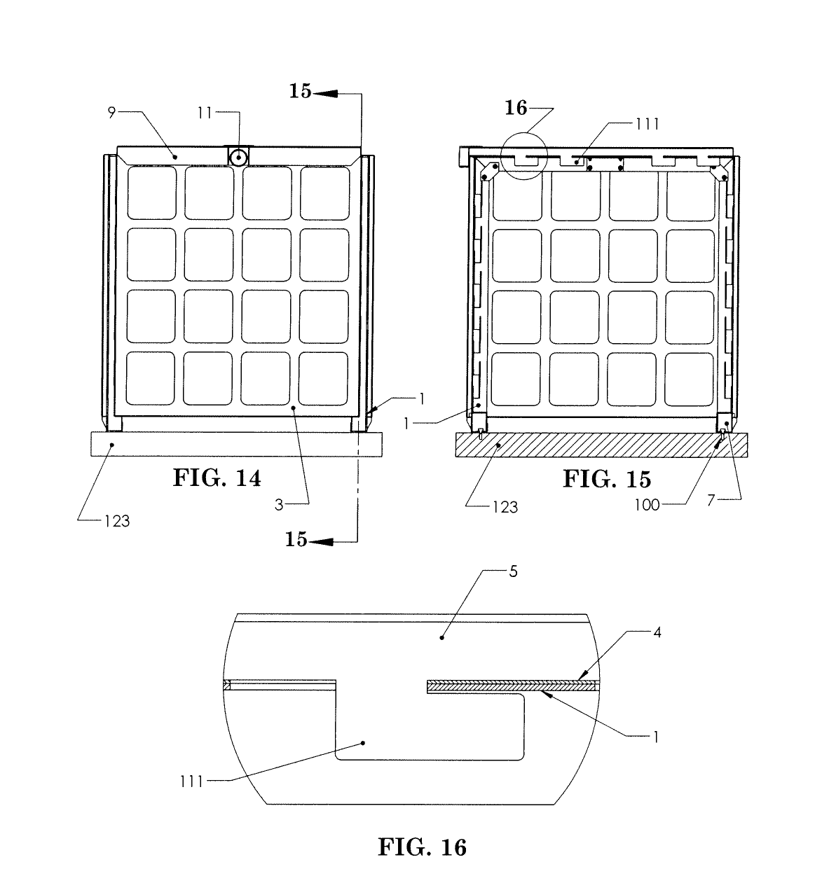

FIG. 14 is an end view of the enclosure of FIG. 12 showing the anchor frame protruding below the side panel 3 of the enclosure, so that the side panels do not contact the base, such as the concrete pad 123.

FIG. 15 is a sectional view taken on lines 15-15 of FIG. 14 which shows the L-shaped hooks engaging the anchor frame 1. A threaded faster 100 is protected by a cover 7 (shown in greater detail in FIGS. 18 and 20).

FIG. 16 is a detailed view of the area 16 in FIG. 15. The top panel 5 has hooks 111 shown as being fully engaged with the slots in side panel 4 and anchor frame 1.

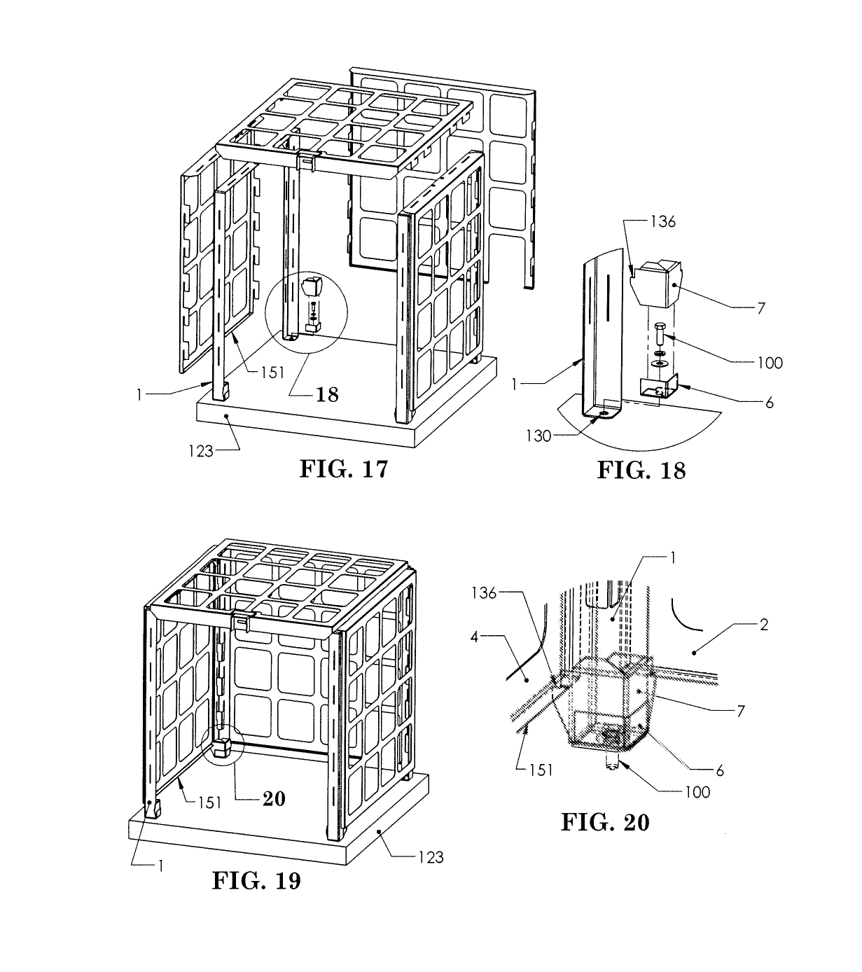

FIG. 17 shows the relationship between the anchor frame and a fastener cover 7 and cover receiver 6. The front facing panel has been omitted for clarity. (See FIG. 18 for details).

FIG. 18 shows a bolt 100 which can be received through a bolt opening 130 in the frame 1 and threaded into an embedded nut in the concrete pad (not shown) or employ a self-threading concrete fastener. The Fastener Cover Receiver 6 is secured by the bolt 100 and together with the anchor frame 1, prevents access to the fastener from the sides. The fastener cover 7 has a protrusion 136 which engages the flange on 151 on the sides (see FIG. 19) whereupon the fastener cover cannot be removed without removing the side panels, which in turn cannot be removed without removing the top panel, which in turn cannot be removed because it is secured by the puck lock.

FIG. 19 shows the enclosure with the fastener cover and fastener cover receiver in position on one leg of the anchor frame 1. The front facing panel is omitted for clarity.

FIG. 20 shows the fastener protected by the fastener cover receiver 6 and fastener cover 7. The protrusion 136 is shown to be engaged with the flange 151. The bolt 100 is made inaccessible to thieves by the fastener cover 7.

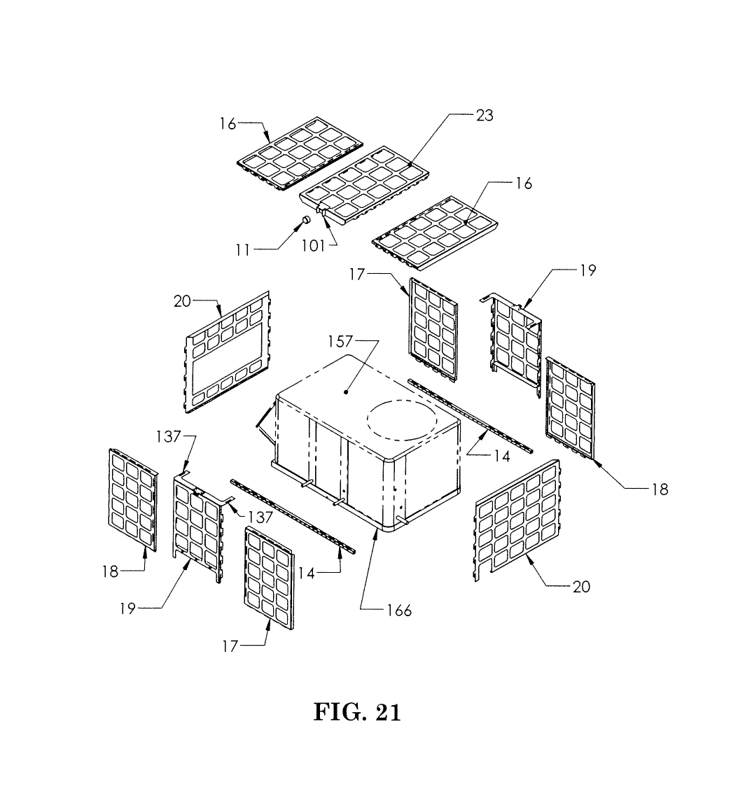

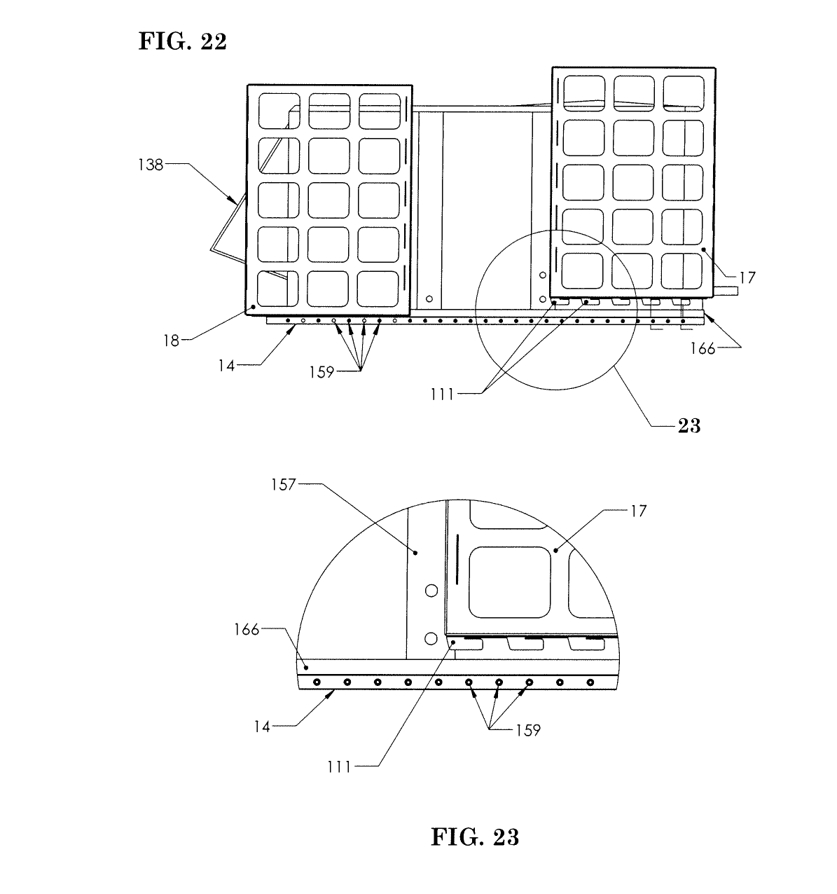

FIG. 21 is an exploded view of the elongated version of the invention, enclosing “rooftop” air-conditioning equipment 157 (shown in dotted lines) where two side panels and a connector panel 19 are used on each elongated side. Here the side panels 17 and 18 and end panels 20 have hooks which are received in slots in side mounting rails 14. The mounting rails can be positioned closely against the equipment 13, so that they overly the skid 166 or can be connected to the skid (see FIGS. 22 and 23). In this way there need be no penetration of the roof surface which minimizes the risk of damage to the roof substrate. The side panels 17 and 18 are connected together with side connector panels 19, top panels 16, and top connector panel 23. The side connector panels 19 have L-shaped extensions 137. The side connector panels are slid into engagement vertically, then the top connector panel 23 is slid horizontally to engage the top of the L-shaped panel extensions 137 and top panels 16. The top connector panel 23 also mounts a lock shroud 101 which protects a puck lock 11 in essentially the same manner as in FIG. 13.

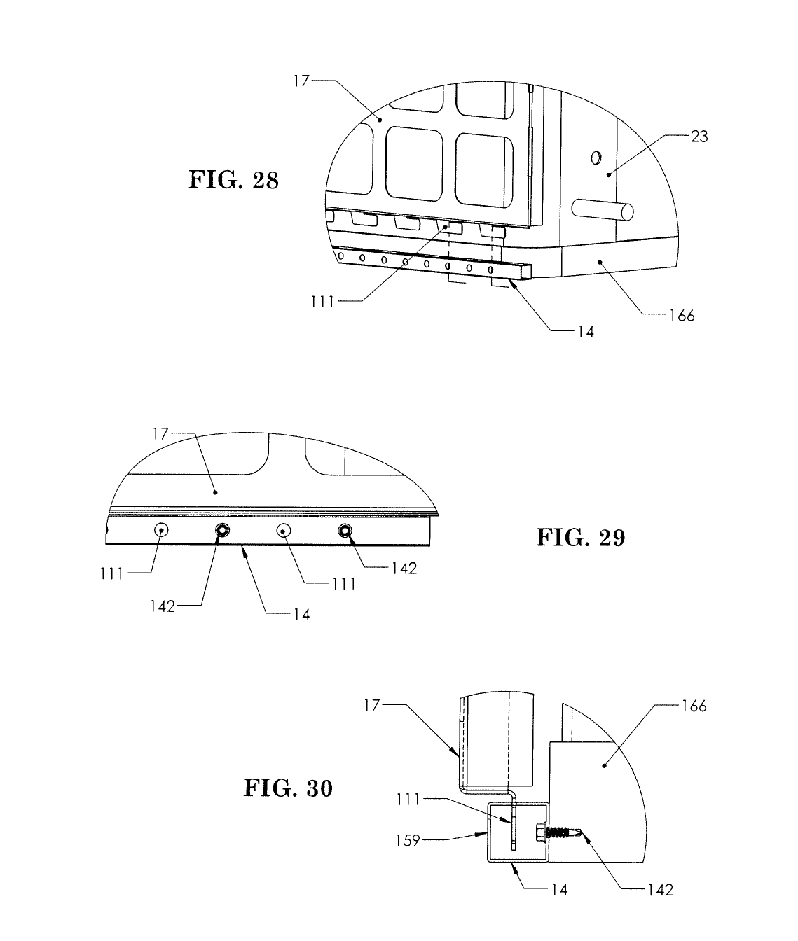

FIG. 22 shows the elongated configuration for the enclosure. The mounting rail 14 is attached to the base of the equipment ‘skid’ 166 through holes such as representative holes 159. Side panel 18 is shown engaged with the mounting rail 14. Side panel 17 is shown in position to be engaged with the rail. The holes are spaced so that a plurality of the fasteners in the holes are inaccessible after the hooks 111 are engaged with the slots in rail 14. The detailed configuration of mounting rail and fasteners is shown in FIGS. 28-30.

FIG. 23 is an enlarged view of area 23 in FIG. 22. The hooks 111 of the side panel 17 are shown to be in position to be lowered into slots on the rail 14. The rail 14 is connected to the skid 166 through fasteners in the openings of which openings 159 are representative.

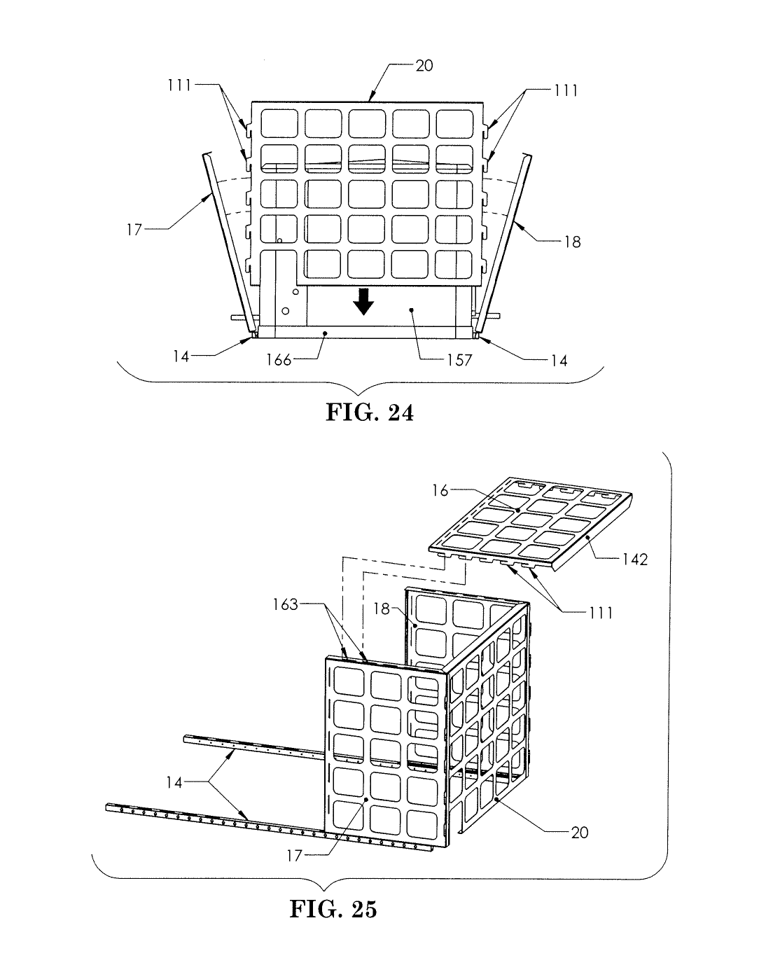

FIG. 24 is an end view of the elongated enclosure, showing how the side panels 17 and 18 can first be engaged with the rails 14 and then pivoted into a vertical orientation ready to receive and engage the end panel 20.

FIG. 25 shows the next step in the assembly of the elongated configuration after the engagement of the end and side panels in FIG. 24. A top panel 16 is shown in position to be lowered with the hooks 111 received into slots in the side panels. Representative slots 163 are shown. After lowering into the slots the top panel 16 is slid horizontally into engagement until the flange guard 142 engages the end panel 20.

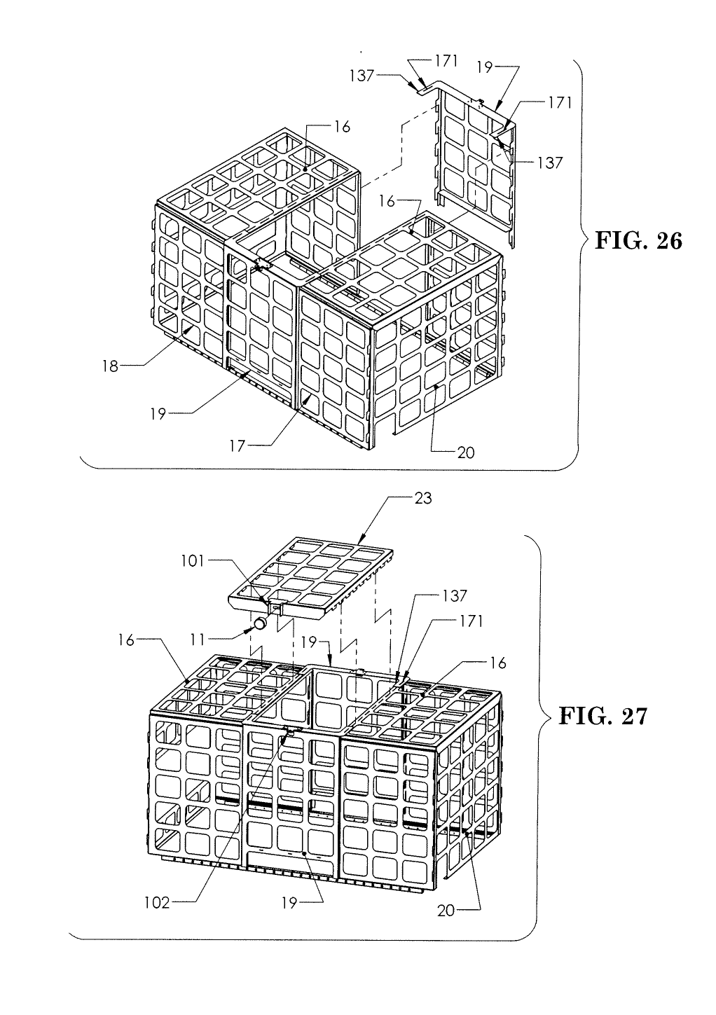

FIG. 26 shows a further step in the assembly of the elongated enclosure where a first side panel connector 19 is engaged with the side panels 17 and 18 and a second side panel connector is shown as being in position to engage the opposite side of the enclosure. The L-shaped extensions 137 have slots 171 which correspond to slots in the top panels 16 so that they are secured by hooks 111 on the top connector panel 23 (see FIG. 27).

FIG. 27 shows the positioning of the final panel, top connector panel 23 which engages slots in the top panels 16 as well as the slots 171 in the L-shaped extensions 137 of the side connector panels 19 (See FIG. 26).

FIG. 28 shows the detail of the engagement of hooks 111 in rails 14 preventing removal of rail fasteners 142. The rail 14 is first secured with screws, the access to which is provided by holes 159. Then when the panel 17 is lowered into position and slid (to the right in the figure), the holes are covered by the hooks 111 so that the screws cannot be accessed.

FIG. 29 shows the screws 142 in place, inserted through holes 159, screwed to equipment skid 166. At least some of the screws 142 are obscured by hooks 111 when side panel 17 is installed. The obscured screws 142 cannot be reached by conventional tools, which prevents the panels such as the illustrated panel 17 from being removed by unauthorized persons.

FIG. 30 shows the screws in place aligned with holes in hooks 111. When the side panel and associated hooks 111 are slid into the locked position the screws will no longer be in alignment with holes 159 and it will not be possible for a thief to use a nut driver to access the screws.

Having described my invention, I now claim:

1. A theft deterrent enclosure for mounting on a base, comprising:
a plurality of panels, including side and top panels;
at least one of said side panels having a plurality of openings to allow the passage of air through said panel;
engagement protrusions along at least one edge of said side panels and inter-fitting engagement openings on an adjacent side panel sized to receive said protrusions;
said engagement openings permitting the sliding of one panel with respect to an adjacent panel to secure the panels together;
a top connector panel having at least one panel section, which together with the top portion of said side panels provides cooperating protrusions and engagement openings, to allow sliding said top panel into engagement with at least two of said side panels;
a lock adapted to engage at least one top panel section to prevent sliding said top panel out of engagement with said at least two of said side panels.

2. The theft deterrent enclosure according to claim 1, further comprising:
a plurality of base fasteners adapted to be secured in a base under the enclosure;
openings in structure connected to the lower portion of said side panels sized to receive a cooperating fastener to engage said openings;

3. The theft deterrent enclosure according to claim 1, further comprising:
A shroud closely surrounding said lock; wherein said lock has no external hasp and has an opening to receive a tang carried on at least one of said panels.

4. The theft deterrent enclosure according to claim 1, wherein:
said side panels are comprised of sheet metal.

5. The theft deterrent enclosure according to claim 1, wherein
upright legs are received between adjacent sides and having cooperating engagement openings and engagement protrusions to secure the sides together.

6. The theft deterrent enclosure according to claim 5, wherein
said legs are connected by a horizontal piece to secure said top panel sections.

7. The theft deterrent enclosure according to claim 1, further comprising:
A plurality of fastener covers positioned to bar access to said fasteners and engaging said sides to prevent removal of said cover after said fastener is tightened.

8. The theft deterrent enclosure according to claim 1, further comprising:
a shroud closely surrounding said lock.

9. The theft deterrent enclosure according to claim 3, wherein:
said shroud is comprised of upraised t metal closely surrounding said lock on at least three sides.

10. The theft deterrent enclosure according to claim 1, wherein:
said lock has no external hasp.

11. The theft deterrent enclosure according to claim 1, wherein:
said lock has an opening which receives a tang carried on said top panel.

12. The theft deterrent enclosure according to claim 3, wherein:
said shroud is comprised of sheet steel.

13. The theft deterrent enclosure according to claim 2, wherein:
a plurality of vertical legs are received between adjacent sides and having inter-fitting engagement openings and engagement protrusions to secure two sides together;
said two legs connected by a horizontal piece to secure the top panel.

14. The theft deterrent enclosure according to claim 1, further comprising:
a plurality of fastener covers positioned to bar access to said fasteners and said fastener covers engaging the lower edge of said panels when installed.

15. The theft deterrent enclosure of claim 14, further including:
fastener cover receivers secured by said bolt and guiding and enclosing the lower ends of said fastener covers.

16. The theft deterrent enclosure according to claim 14, wherein:
said fastener covers are received within said fastener cover receivers.

17. The theft deterrent enclosure of claim 16, further including:
a plurality of top connector panels parts bridging between said top panels.

18. The theft deterrent enclosure of claim 17, wherein:
said top connector panels mounting a lock shroud on one of said panels and a lock tang on the other of said top connector panels.

19. The theft deterrent enclosure of claim 18, further including:
a lock positioned in said lock shroud and having an opening to receive and engage said lock tang.

20. The theft deterrent enclosure of claim 18, wherein:
said side panels are comprised of sheet steel.

21. The theft deterrent enclosure of claim 18, wherein:
said shroud comprising upraised metal closely surrounding said lock on at least three sides.

22. A theft deterrent enclosure for mounting on a base, comprising:
a plurality of panels, including side and top panels;
a least one of said side panels having a plurality of openings to allow the passage of air through said panel;
engagement protrusions and inter-fitting engagement openings on an adjacent side panels where said opening are sized to receive said protrusions;
said engagement openings permitting the sliding of one panel with respect to an adjacent panel to secure the panels together;
at least one top connector panel having at least one panel section, which together with the top portion of said side panels provide cooperating protrusions and engagement openings, to allow sliding said top panel into engagement with at least two of said side panels.

23. The theft deterrent enclosure of claim 4, wherein:
said sheet metal comprises sheet steel.
